(19) United States
(12) Patent Application Publication
(10) Pub. No.: US 2026/0243978 A1
(43) Pub. Date: Aug. 20, 2026

(54) Integrated optical element and assembly method thereof

(71) Applicants: Yuan-Piao LIN, Taoyuan (TW); Hung-Hsien LIN, Taoyuan (TW); Wei-Bo LIN, Hsinchu (TW)

(72) Inventors: Yuan-Piao LIN, Taoyuan (TW); Hung-Hsien LIN, Taoyuan (TW); Wei-Bo LIN, Hsinchu (TW)

(21) Appl. No.: 19/058,238

(22) Filed: Feb. 20, 2025

(51) Int. Cl. G02B 6/42; G02B 6/43

(52) U.S. Cl. CPC G02B 6/4244; G02B 6/4228; G02B 6/428; G02B 6/43

(57) ABSTRACT

An integrated optical element for receiving an optical signal includes a substrate, a semiconductor optical device, at least one optical element array, and a soldering fixation material. The substrate includes an upper surface. The semiconductor optical device is arranged on the upper surface. The at least one optical element array is arranged along a plane direction of the substrate above the upper surface and aligned with the semiconductor optical device in an optical axis direction. The soldering fixation material is arranged on the upper surface and beneath the optical element array. Before the soldering fixation material secures the at least one optical element array to the substrate, the at least one optical element array is arranged in a space through a plurality of temporary support structures to maintain a distance from the upper surface. The temporary support structures are removed after the soldering fixation material is solidified.

### FIELD OF THE INVENTION

The invention relates to a semiconductor element and an assembly method thereof, particularly to an integrated optical element and an assembly method that enhances the precision of integrated optical element assembly.

### BACKGROUND OF THE INVENTION

With technological advancements, integrated optical elements (such as silicon photonics) have gained attention due to their high performance, low power consumption, and compact size. These elements receive optical signals transmitted through optical fibers (e.g., visible light, infrared) and convert them into electrical signals via semiconductor devices for processing. In typical integrated optical element configurations, lens assemblies are used to direct optical signals to the correct receiving position within the semiconductor device. If the lens assembly is slightly misaligned, it may affect the accuracy of optical signal transmission. This issue is especially critical as chip packaging trends toward miniaturization. Traditional lens assemblies are secured to the substrate by adhesives, but adhesives exist in liquid form before solidifying, making them susceptible to gravity and shrinkage during solidifying, leading to slight deviations in assembly that impact optical signal transmission.

### SUMMARY OF THE INVENTION

A primary object of the invention is to address the issue of poor assembly precision in conventional integrated optical elements.

In order to achieve the above object, the invention provides an integrated optical element for receiving an optical signal. The integrated optical element includes a substrate, a semiconductor optical device, at least one optical element array, and a soldering fixation material. The substrate extends along a planar direction and includes an upper surface. The semiconductor optical device is positioned on the upper surface of the substrate. The at least one optical element array includes a plurality of optical elements arranged in an array along the planar direction above the upper surface. The optical elements are positioned in front of the semiconductor optical device and aligned with the semiconductor optical device in an optical axis direction. The soldering fixation material is positioned on the upper surface and beneath the at least one optical element array. Before the soldering fixation material secures at least one optical element array to the substrate, the optical elements are arranged in an array in a space through a plurality of temporary support structures to maintain a distance from the upper surface while being aligned in the optical axis direction with the semiconductor optical device. After the soldering fixation material is fixed and solidified on the upper surface, the temporary support structures are removed.

In order to achieve the above object, the invention also discloses a method for assembling an integrated optical element, which includes: providing a substrate extending along a planar direction and including an upper surface; arranging a plurality of temporary support structures on the upper surface; placing a plurality of optical elements onto the temporary support structures to form at least one optical element array, wherein the at least one optical element array is arranged in an array along the planar direction while maintaining a distance from the upper surface and being aligned in an optical axis direction with a semiconductor optical device; arranging a non-solid phase soldering fixation material between the at least one optical element array and the upper surface; and removing the temporary support structures after solidifying the non-solid phase soldering fixation material into a solid phase soldering fixation material.

### BRIEF DESCRIPTION OF THE DRAWINGS

FIG. 1 is a top view schematic of an embodiment of the invention.

FIG. 2 is a side view schematic of an embodiment of the invention.

FIG. 3 is a top view schematic of another embodiment of the invention.

FIGS. 4 to 6 are assembly step schematics of an embodiment of the invention.

FIG. 7 is an assembly schematic of another embodiment of the invention.

### DETAILED DESCRIPTION OF THE PREFERRED EMBODIMENTS

The terminology used in this document is intended to describe specific embodiments and should not be interpreted as limiting the invention. Unless otherwise specified in the context, singular terms such as 'a' and 'the' may also include plural forms.

Directional terms such as up, down, left, right, front, and back, along with their derivatives or synonyms, refer to the orientation of elements in the figures and are not meant to limit the invention unless explicitly stated.

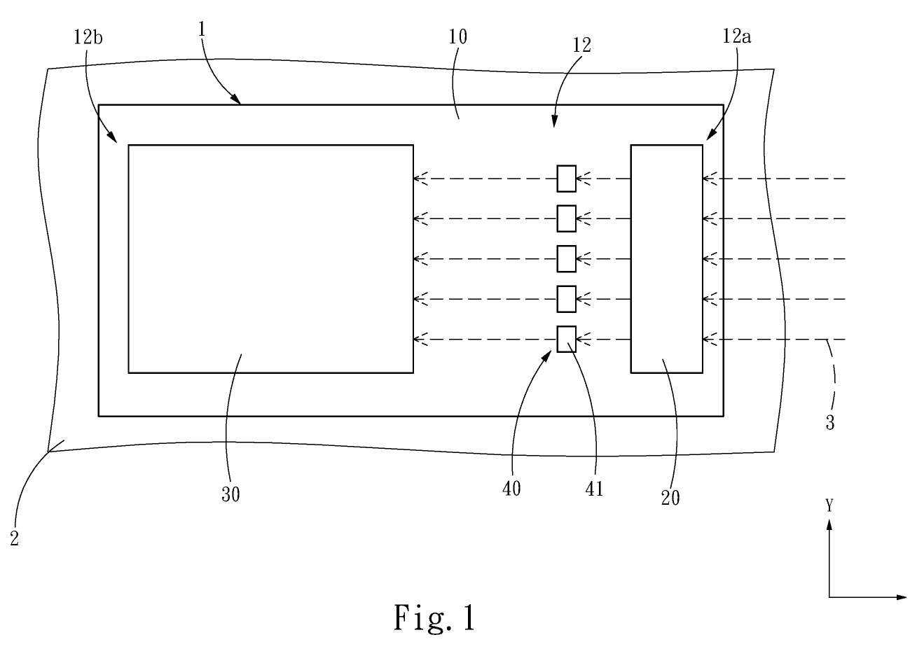

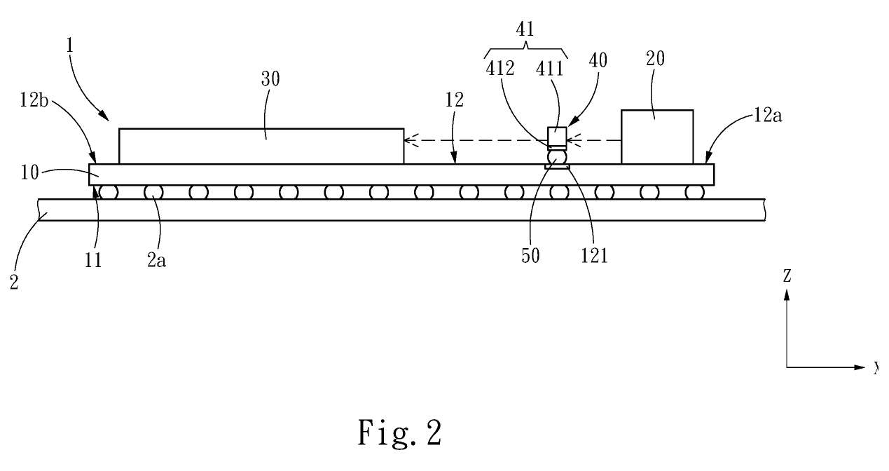

The invention provides an integrated optical element and an assembly method thereof. As shown in FIGS. 1 and 2, the integrated optical element 1 is coupled to a high-speed circuit substrate 2 via a copper bonding bump 2a to transmit signals. The integrated optical element 1 includes a substrate 10, a light-emitting device 20, a semiconductor optical device 30, and at least one optical element array 40.

The substrate 10 extends along a planar direction (XY plane) and includes a lower surface 11 and an upper surface 12. The lower surface 11 connects to the high-speed circuit substrate 2 via the copper bonding bump 2a for signal transmission. The upper surface 12 is disposed with the light-emitting device 20, the semiconductor optical device 30, and the at least one optical element array 40.

The light-emitting device 20 is positioned on a first side 12a of the upper surface 12 and emits at least one optical signal 3 along an optical axis direction (X direction). The light-emitting device 20 may, but is not limited to, be an optical signal output element or an optical output device of another integrated optical element, such as a semiconductor laser or an optical fiber module. The at least one optical signal 3 outputs to the at least one optical element array 40 through the light-emitting device 20.

The semiconductor optical device 30 is connected to the upper surface 12 of the substrate 10 and transmits signals. The semiconductor optical device 30 is positioned on a second side 12b of the upper surface 12. In this embodiment, the semiconductor optical device 30 may be, but is not limited to, a 2D optical system-on-chip or a 3D optical system-on-chip.

The at least one optical element array 40 includes a plurality of optical elements 41 arranged on the upper surface 12 in the planar direction. The optical elements 41 are arranged in an array along the planar direction above the upper surface 12. The at least one optical element array 40 is positioned in front of the semiconductor optical device 30 and behind the light-emitting device 20, aligning with the semiconductor optical device 30 and the light-emitting device 20 along the optical axis direction. The invention does not limit to shapes of the optical elements 41, but is determined based on an overall configuration of the integrated optical element 1. The optical elements 41 may, but is not limited to, be a lens.

The at least one optical element array 40 is fixed to the substrate 10 by a soldering fixation material 50. The soldering fixation material 50 is located beneath the at least one optical element array 40 and may be a ball grid array, a solder paste, or a combination thereof. In this embodiment, the soldering fixation material 50 excludes using adhesives.

In this embodiment, the upper surface 12 includes a plurality of first solder pads 121 corresponding to the optical elements 41. Each of the optical elements 41 includes a lens 411 and a second solder pad 412 connected to the lens 411. When the soldering fixation material 50 connects the optical elements 41 to the substrate 10, the second solder pad 412 is correspondingly aligned with the first solder pads 121, ensuring that the lens 411 is aligned with the semiconductor optical device 30 and the light-emitting device 20 along the optical axis direction. The first solder pads 121 and the second solder pads 412 facilitate the wetting and fixation of the soldering fixation material 50. The first solder pads 121 and the second solder pad 412 are made of metallic materials, such as gold, copper, or aluminum.

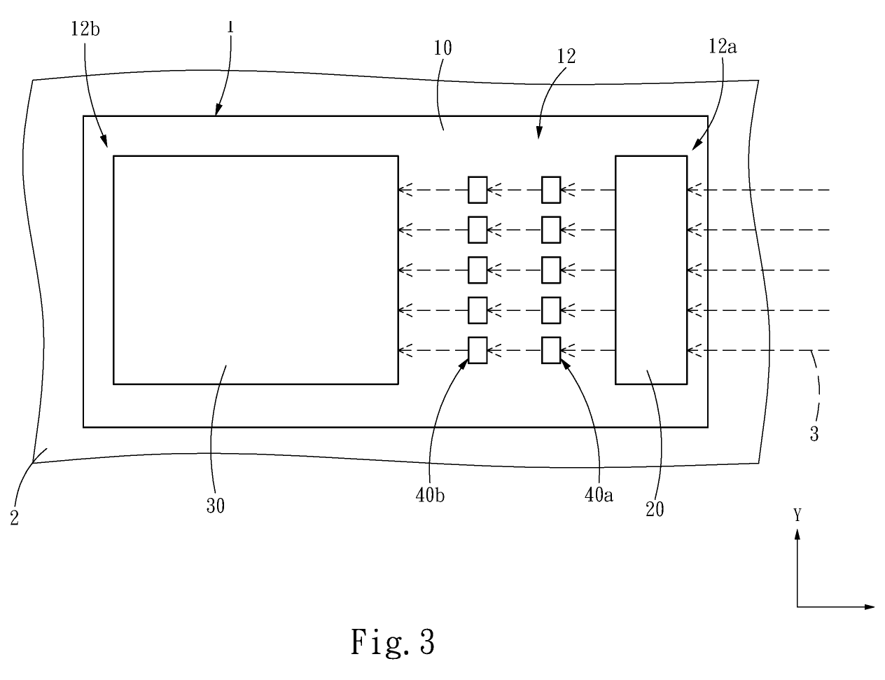

In one embodiment, as shown in FIG. 3, the at least one optical element array 40 may include a first optical element array 40a and a second optical element array 40b. The first optical element array 40a and the second optical element array 40b are arranged in an array along the planar direction and are spaced apart from each other along the optical axis direction.

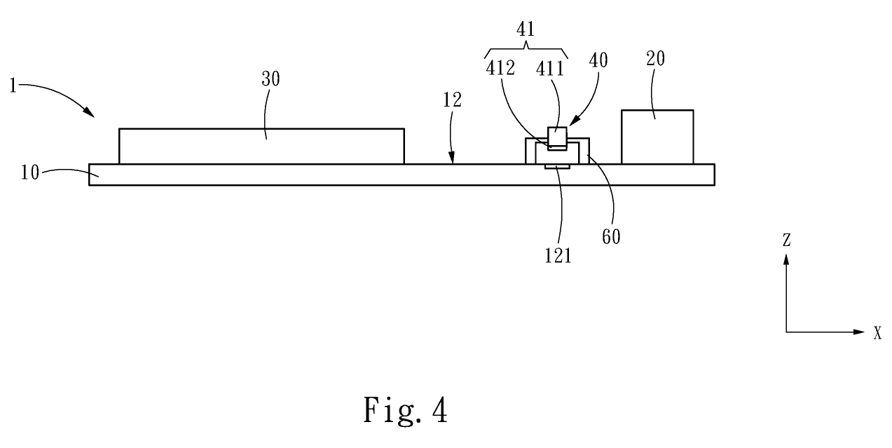

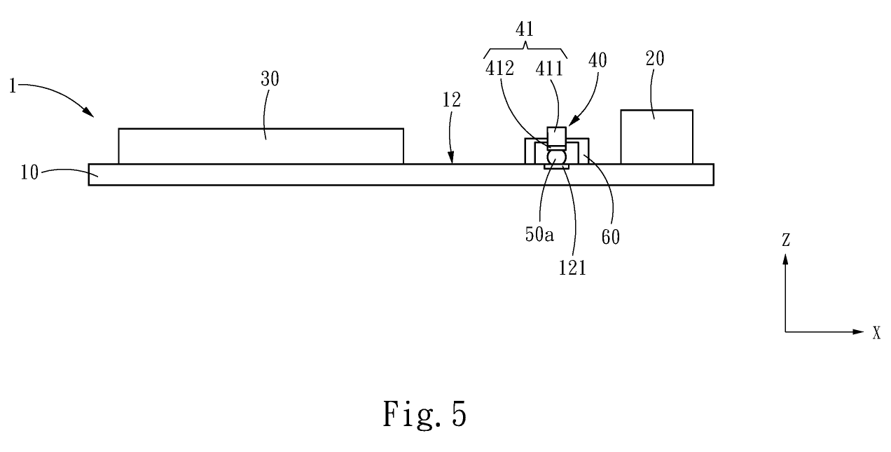

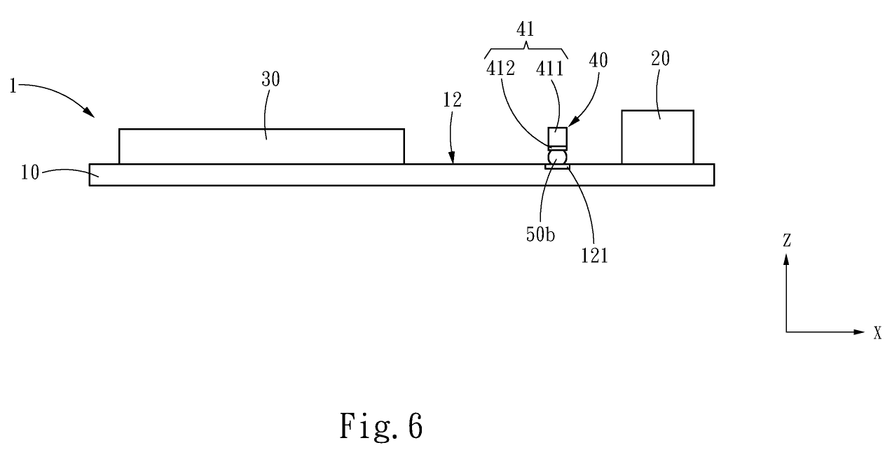

Referring to FIG. 4, FIG. 5 and FIG. 6, to ensure precise alignment of the at least one optical element array 40 with the semiconductor optical device 30 and the light-emitting device 20, the application further discloses a method for assembling the integrated optical element 1.

First, as shown in FIG. 4, a substrate 10 is provided, which may be pre-equipped with the light-emitting device 20 and the semiconductor optical device 30. Next, a plurality of temporary support structures 60 are arranged on the upper surface 12 of the substrate 10, positions of the temporary support structures 60 are based on where the at least one optical element array 40 is designed to be placed on the substrate 10. Then, the optical elements 41 are positioned on the temporary support structures 60 to form the at least one optical element array 40. The optical elements 41 are arranged in an array along the planar direction and are spaced at a distance from the upper surface 12. This ensures that lenses 411 of the optical elements 41 are aligned with the semiconductor optical device 30 along the optical axis direction. In other words, before the soldering fixation material 50 connects the at least one optical element array 40 to the substrate 10, the at least one optical element array 40 is arranged in a space above the upper surface 12 through the temporary support structures 60.

As shown in FIG. 5, a non-solid phase soldering fixation material 50a is applied and connected between the second solder pad 412 of the optical elements 41 of the at least one optical element array 40 and the first solder pads 121 on the upper surface 12. The non-solid phase soldering fixation material 50a may be a molten solder ball or solder paste.

As shown in FIG. 6, after the non-solid phase soldering fixation material 50a solidifies into a solid phase soldering fixation material 50b, the temporary support structures 60 are removed.

As a result, the optical elements 41 remain aligned with the semiconductor optical device 30 along the optical axis direction while being placed on the temporary support structures 60. Additionally, when the non-solid phase soldering fixation material 50a is introduced between the optical elements 41 and the substrate 10, the optical elements 41 do not sink into the non-solid phase soldering fixation material 50a due to gravity. Once the non-solid phase soldering fixation material 50a cools down and solidifies into the solid phase soldering fixation material 50b, the temporary support structures 60 are removed, effectively solving the issue of the optical elements 41 sinking due to gravity. This significantly enhances the alignment precision of the at least one optical element array 40 with the semiconductor optical device 30 along the optical axis direction.

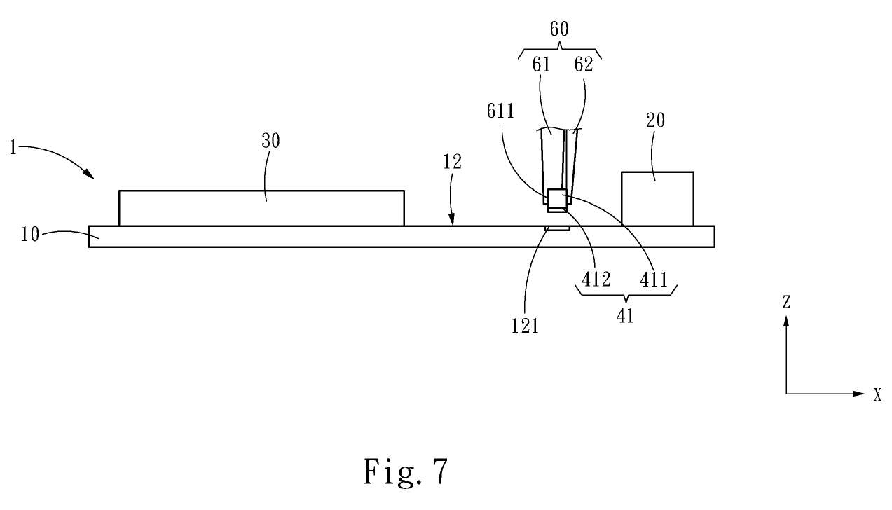

In another embodiment of this invention, as shown in FIG. 7, the temporary support structures 60 hold the optical elements 41 from above without contacting the upper surface 12 of the substrate 10. This ensures that the optical elements 41 remains spaced apart from the upper surface 12 and is aligned with the semiconductor optical device 30 along the optical axis direction. In this embodiment, the temporary support structures 60 may, but are not limited to, being controlled by a robotic arm.

Each of the temporary support structures 60 include a first clamping member 61 and a second clamping member 62. The first clamping member 61 includes a positioning section 611 adhered to an edge of each of the optical elements 41 to secure a position of each of the optical elements 41. If each of the optical elements 41 is in rectangular shape, the positioning section 611 is designed to fit and adhere to adjacent surface of the rectangle shape, thereby positioning each of the optical elements 41. When the first clamping member 61 and the second clamping member 62 clamp each of the optical elements 41, the positioning section 611 ensures relative positions of each of the optical elements 41 and each of the temporary support structures 60, keeping the optical elements 41 aligned with the semiconductor optical device 30.

According to the above, this invention ensures precise optical elements assembly by first securing positions of the optical elements through the temporary support structures. After the soldering fixation material solidifies, the temporary support structures are removed, preventing alignment errors caused by gravity. Furthermore, using solder balls or solder paste as the soldering fixation material enhances the solidification speed.

What is claimed is:

1. An integrated optical element, provided for receiving an optical signal, the integrated optical element comprising:
a substrate, extending along a planar direction and comprising an upper surface;
a semiconductor optical device, positioned on the upper surface of the substrate;
at least one optical element array, comprising a plurality of optical elements arranged in an array along the planar direction above the upper surface, and the plurality of optical elements positioned in front of the semiconductor optical device and aligned with the semiconductor optical device in an optical axis direction; and
a soldering fixation material, positioned on the upper surface and beneath the at least one optical element array,
wherein, before the soldering fixation material fixing the at least one optical element array to the substrate, the plurality of optical elements are arranged in a space through a plurality of temporary support structures to maintain a distance from the upper surface while being aligned in the optical axis direction with the semiconductor optical device;
wherein, after the soldering fixation material is fixed and solidified on the upper surface, the temporary support structures are removed.

2. The integrated optical element as claimed in claim 1, wherein the soldering fixation material is a non-solid phase before connecting the at least one optical element array to the substrate.

3. The integrated optical element as claimed in claim 1, wherein the soldering fixation material is a solid phase after connecting the at least one optical element array to the substrate and cooling down.

4. The integrated optical element as claimed in claim 1, wherein the soldering fixation material is a ball grid array, a solder paste, or a combination thereof.

5. The integrated optical element as claimed in claim 1, wherein the temporary support structures are arranged on the upper surface of the substrate.

6. The integrated optical element as claimed in claim 1, wherein each of the temporary support structures comprises a first clamping member and a second clamping member, and each of the plurality of optical elements is clamped by one of the first clamping members and one of the second clamping members.

7. The integrated optical element as claimed in claim 6, wherein the first clamping member comprises a positioning section, when the first clamping member and the second clamping member clamp each of the optical elements, the positioning section is adhered to an edge of each of the optical elements to secure a position of each of the optical elements.

8. The integrated optical element as claimed in claim 1, wherein a plurality of first solder pads arranged on the upper surface of the substrate, and each of the optical elements comprises a second solder pad, and the soldering fixation material is connected to one of the first solder pads and one of the second solder pads.

9. An assembly method of integrated optical element, comprising:
providing a substrate, extending along a planar direction and comprising an upper surface;
arranging a plurality of temporary support structures on the upper surface;
placing a plurality of optical elements on the temporary support structures to form at least one optical element array, wherein the at least one optical element array are arranged in an array along the planar direction to maintain a distance from the upper surface while being aligned in an optical axis direction with a semiconductor optical device;
arranging a non-solid phase soldering fixation material between the at least one optical element array and the upper surface; and
removing the temporary support structures after solidifying the non-solid phase soldering fixation material into a solid phase soldering fixation material.

10. The assembly method of integrated optical element in claim 9, wherein the non-solid phase soldering fixation material is a ball grid array, a solder paste, or a combination thereof.
